(19) United States
(12) Patent Application Publication
(10) Pub. No.: US 2006/0228503 A1
(43) Pub. Date: Oct. 12, 2006

(54) Film for chub packaging

(76) Inventors: Marvin Havens, Greer, SC (US); Susannah Gelotte, Simpsonville, SC (US); David Babb, Duncan, SC (US); Jeffrey Boland, Moore, SC (US); Solomon Bekele, Taylors, SC (US)

Correspondence Address: Cryovac, Inc., P.O. Box 464, Duncan, SC, 29334, US

(21) Appl. No.: 11/361,616

(22) Filed: Feb. 24, 2006

Related U.S. Application Data
(63) Continuation-in-part of application No. 11/268,210, filed on Nov. 7, 2005.
(60) Provisional application No. 60/670,363, filed on Apr. 12, 2005.
(60) Provisional application No. 60/672,367, filed on Apr. 18, 2005.
(60) Provisional application No. 60/687,592, filed on Jun. 3, 2005.

(51) Int. Cl. B32B 27/08

(52) U.S. Cl. 428/35.7

(57) ABSTRACT

A tubular lay-flat film includes outer polymeric layers, at least one intermediate layer including a polyamide, and self-welded polymeric layers in contact with one another; wherein in various embodiments (a) the outer polymeric layers each include a blend of an olefinic polymer and a polydimethylsiloxane; (b) the at least one intermediate layer including a polyamide includes a blend of polyamide and ionomer resin; and (c) the self-welded polymeric layers each include a blend of an anhydride grafted ethylene copolymer having a density of from 0.916 to 0.935 grams/cubic centimeter, and a single site catalyzed ethylene/alpha-olefin copolymer having a density of from 0.85 to 0.915 grams/cubic centimeter.

This application is a continuation-in-part application of U.S. application Ser. No. 11/268,210 filed Nov. 7, 2005 which claims the benefit of U.S. Provisional Application Ser. No. 60/670,363 filed Apr. 12, 2005, U.S. Provisional Application Ser. No. 60/672,367 filed Apr. 18, 2005, and U.S. Provisional Application Ser. No. 60/687,592 filed Jun. 3, 2005, the contents of which are hereby incorporated by reference.

### FIELD OF THE INVENTION

The present invention relates to a film suitable for the packaging of chubs of meat, and a process of packaging meat chubs.

### BACKGROUND OF THE INVENTION

Certain foods, and particularly meat products such as ground beef and other comminuted food substances, are commonly packaged in what are called chub packages. These packages are generally produced at central processing plants operated by super-market chains or meat packing companies. These packages are generally produced using a vertical form fill seal (VFFS) process, in which a tube is formed from a flat sheet of roll stock film. The tube is formed vertically and longitudinally sealed with a vertical sealing bar. The bottom of the tube is then sealed with a metal clip applied to the bottom of the tube, the meat product such as ground beef is pumped into the open end of the tube, and the top is sealed with another metal clip to produce the final chub package. In appearance, these chubs resemble semi-rigid tubes with the tubular film forming a skin tight layer around the food product. Package sizes may range from 1 to 20 pounds, depending on the intended mode of distribution. Crust-frozen items have become more popular, and the hardening of the outer surface of the food product in the tubular casing during the freezing process (typically using blast freezers) can produce stress on the package during the portion of the packaging process after the freezing step. A commercially available film currently used in chub packaging applications is the HS3000™ film produced by Cryovac, Inc., a subsidiary of Sealed Air Corporation. U.S. Pat. No. 4,909,726 (Bekele), incorporated herein by reference in its entirety, discloses films useful in packaging ground meat in chub packages.

### SUMMARY OF THE INVENTION

In a first aspect, a tubular lay-flat film comprises first and second outer layers comprising an olefinic polymer; at least one intermediate layer comprising a polyamide; and first and second internal self welded layers in contact with one another, the first and second internal layers comprising an olefinic polymer, wherein the first and second outer polymeric layers each comprise a blend of an olefinic polymer, and polydimethylsiloxane.

In a second aspect, a tubular lay-flat film comprises first and second outer layers comprising an olefinic polymer; at least one intermediate layer comprising a blend of polyamide and ionomer resin; and first and second internal self welded layers in contact with one another, the first and second internal self welded layers comprising an olefinic polymer.

In a third aspect, a tubular lay-flat film comprises first and second outer layers comprising an olefinic polymer; at least one intermediate layer comprising a polyamide; and first and second internal self-welded layers in contact with one another, the first and second internal layers each comprising a blend of an anhydride grafted ethylene copolymer having a density of from 0.916 to 0.935 grams/cubic centimeter, and a single site catalyzed ethylene/alpha-olefin copolymer having a density of from 0.85 to 0.915 grams/cubic centimeter.

In a fourth aspect, a multilayer film comprises a first layer comprising a blend of an olefinic polymer and polydimethylsiloxane; a second layer comprising an olefinic polymer; a third layer comprising a polyolefinic adhesive; a fourth layer comprising a polyamide; a fifth layer comprising an ethylene/vinyl alcohol copolymer; a sixth layer comprising a polyamide; and a seventh layer comprising a polymeric adhesive.

In a fifth aspect, a multilayer film comprises a first layer comprising an olefinic polymer; a second layer comprising an olefinic polymer; a third layer comprising a polyolefinic adhesive; a fourth layer comprising a blend of polyamide and ionomer resin; a fifth layer comprising an ethylene/vinyl alcohol copolymer; a sixth layer comprising a blend of polyamide and ionomer resin; and a seventh layer comprising a polymeric adhesive.

In a sixth aspect, a multilayer film comprises a first layer comprising an olefinic polymer; a second layer comprising an olefinic polymer; a third layer comprising a polyolefinic adhesive; a fourth layer comprising a polyamide; a fifth layer comprising an ethylene/vinyl alcohol copolymer; a sixth layer comprising a polyamide; and a seventh layer comprising a blend of an anhydride grafted ethylene copolymer having a density of from 0.916 to 0.935 grams/cubic centimeter, and a single site catalyzed ethylene/alpha-olefin copolymer having a density of from 0.85 to 0.915 grams/cubic centimeter.

In a seventh aspect, a process for packaging a comminuted food substance comprises packaging the comminuted food substance in a vertical form/fill/seal process in a tubular lay-flat film comprising first and second outer layers comprising an olefinic polymer, at least one intermediate layer comprising a polyamide, and first and second internal self welded layers in contact with one another, the first and second internal self welded layers comprising an olefinic polymer, wherein the first and second outer polymeric layers each comprise a blend of an olefinic polymer, and polydimethylsiloxane, such that a chub package is made; passing the chub package through a blast freezer; removing the chub package from the blast freezer; and packing the chub package in a shipping container.

In an eighth aspect, a process for packaging a comminuted food substance comprises packaging the comminuted food substance in a vertical form/fill/seal process in a tubular lay-flat film comprising first and second outer layers comprising an olefinic polymer, at least one intermediate layer comprising a blend of polyamide and ionomer resin, and first and second internal self welded layers in contact with one another, the first and second internal self-welded layers comprising an olefinic polymer, such that a chub package is made; passing the chub package through a blast freezer; removing the chub package from the blast freezer; and packing the chub package in a shipping container.

In a ninth aspect, a process for packaging a comminuted food substance comprises packaging the comminuted food substance in a vertical form/fill/seal process in a tubular lay-flat film comprising first and second outer layers comprising an olefinic polymer, at least one intermediate layer comprising a polyamide, and first and second internal self-welded layers in contact with one another, the first and second internal self-welded layers each comprising a blend of an anhydride grafted ethylene copolymer having a density of from 0.916 to 0.935 grams/cubic centimeter, and a single site catalyzed ethylene/alpha-olefin copolymer having a density of from 0.85 to 0.915 grams/cubic centimeter, such that a chub package is made; passing the chub package through a blast freezer; removing the chub package from the blast freezer; and packing the chub package in a shipping container.

Definitions

“polymer” herein refers to the product of a polymerization reaction, and is inclusive of homopolymers, copolymers, terpolymers, tetrapolymers, etc.;

“copolymer” herein refers to a polymer formed by the polymerization reaction of at least two different monomers and is inclusive of random copolymers, block copolymers, graft copolymers, etc.;

“polyamide” herein refers to both polyamides and copolyamides;

“ethylene/alpha-olefin copolymer” (EAO) herein refers to copolymers of ethylene with one or more comonomers selected from C₃ to C₁₀ alpha-olefins such as propene, butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to EAOs and which high pressure polyethylenes contain both long chain and short chain branches. EAO includes such heterogeneous materials as linear medium density polyethylene (LMDPE), linear low density polyethylene (LLDPE), and very low and ultra low density polyethylene (VLDPE and ULDPE), such as DOWLEX™ and ATTANE™ resins supplied by Dow, and certain resins supplied by Exxon; as well as linear homogeneous ethylene/alpha olefin copolymers (HEAO) such as TAFMER™ resins supplied by Mitsui Petrochemical Corporation, EXACT™ and EXCEED™ resins supplied by Exxon, long chain branched (HEAO) AFFINITY™ resins and ELITE™ resins supplied by the Dow Chemical Company, ENGAGE™ resins supplied by DuPont Dow Elastomers, and SURPASS™ resins supplied by Nova Chemicals;

“ionomer resin” herein refers to a polymer containing interchain ionic bonding, and in one embodiment more particularly refers to a thermoplastic polymer based on metal salts of copolymers of ethylene and a vinyl monomer with an acid group, such as methacrylic acid. Examples of ionomer resins are those produced by DuPont under the trademark SURLYN™. Examples of metals of the metal salts include lithium, sodium, potassium, and zinc. The ionomer resin can be a conventional ionomer resin such as those sold under the SURLYN™ trademark, and can in some cases be preblended with a polyamide, typically processed at e.g. about 50% polyamide and about 50% ionomer resin, by weight of the preblend, in a twin screw extruder to facilitate intimate blending of the two materials. The result is reflected in the SURLYN™ AM™ series of resins from DuPont, e.g. AM7927™. In embodiments of the invention where a blend of polyamide and ionomer resin are utilized, the blend can reflect the use of a polyamide, and an ionomer resin without any preblended polyamide. In some film production processes, such a blend may not produce a totally satisfactory film. In such cases, the preblend disclosed herein, e.g. an AM™ series blend or an equivalent, can be purchased from a vendor such as DuPont and then further blended with additional polyamide in the process of producing a film. The amount of additional polyamide added to the polyamide/ionomer preblend can be controlled to arrive at the desired blend in the final film. In either approach, the result is a blend of polyamide and ionomer resin, with the ionomeric portion separately identifiable from the polyamide portion of the blend.

“package” herein refers to a film configured around a product;

“film” herein refers to plastic web materials having a thickness of 0.50 mm (20 mils) or less such as 0.25 mm (10 mils) or less;

“seal layer” herein refers to a layer of a film that can be involved in the sealing of the film to itself or another layer;

“seal” herein refers to a bonding of a first film surface to a second film surface created by heating (e.g., by means of a heated bar, hot air, infrared radiation, ultrasonic sealing, etc.) the respective surfaces to at least their respective seal initiation temperatures;

“polyolefinic adhesive” herein refers to material used in a layer of a film that can provide interlayer adhesion to adjacent layers that include otherwise nonadhering or weakly adhering polymers;

“total free shrink” means the percent dimensional change in a 10 cm×10 cm specimen of film, when shrunk at a specified test temperature such as 85° C. (185° F.), with the quantitative determination being carried out according to ASTM D 2732-03. “Total free shrink” refers to the totality of the free shrink in both the longitudinal direction and the transverse direction.

“machine direction” herein refers to the direction along the length of a film, i.e., in the direction of the film as it is formed during extrusion and/or coating; and

“transverse direction” herein refers to the direction across a film, i.e., the direction that is perpendicular to the machine direction.

“Linear low density polyethylene” (LLDPE) herein refers to polyethylene having a density from 0.915 to 0.925 grams per cubic centimeter, that is organometallic catalyzed.

“Very low density polyethylene” (VLDPE) and “Ultra low density polyethylene” (ULDPE) herein refer to ethylene/alpha olefin copolymers having a density below 0.915 grams per cubic centimeter.

“Linear medium density polyethylene” (LMDPE) herein refers to polyethylene having a density from 0.926 grams per cubic centimeter to 0.939 grams per cubic centimeter, made by Zeigler/Natta catalysis.

“Solid state oriented” herein refers to films obtained by either co-extrusion or extrusion coating of the resins of different layers to obtain a primary thick sheet or tube (primary tape) that is quickly cooled to a solid state to quench (stop or slow) crystallization of the polymers, thereby providing a solid primary film sheet. The primary sheet is then reheated to the so-called orientation temperature, and thereafter biaxially stretched at the orientation temperature using either a tubular solid-state orientation process (for example a trapped bubble method) or using a flat solid-state orientation process (for example a simultaneous or sequential tenter frame), and finally rapidly cooled below the orientation temperature to provide a heat shrinkable film. In the trapped bubble solid state orientation process, the primary tape is stretched in the transverse direction (TD) by passing over an air bubble which is held between two rotating nip rolls, as well as stretched in the longitudinal direction (LD) by the differential speed between the two sets of nip rolls that contain the bubble. In the tenter frame process, the sheet or primary tape is stretched in the longitudinal direction by accelerating the sheet forward, while simultaneously or sequentially accelerating the sheet in the transverse direction by guiding the heat softened sheet through a diverging geometry frame. This tenter process typically refers to a flat sheet of relatively thick film. Solid state oriented films exhibit high free shrink when reheated to their orientation temperature.

“unoriented” herein refers to a film that has not been solid state oriented.

All compositional percentages used herein are presented on a “by weight” basis, unless designated otherwise.

### BRIEF DESCRIPTION OF THE DRAWINGS

A detailed description of embodiments of the invention follows, with reference to the attached drawings, wherein:

FIG. 1 is a schematic cross-section of a double wound, lay-flat tubular film according to an embodiment of the present invention.

### DETAILED DESCRIPTION OF THE INVENTION

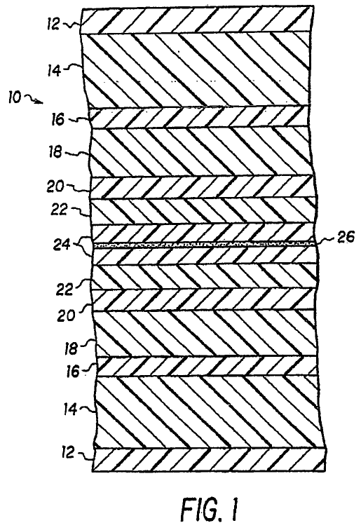

Referring to FIG. 1, a hot blown film 10 includes a heat sealable layer 12 comprising an olefinic polymer. An example is ethylene/ester copolymer, such as an ethylene/vinyl acetate copolymer (EVA), e.g. an EVA with between about 4% and 12%, by weight of the copolymer, of vinyl acetate comonomer. An example is a 5½ weight % vinyl acetate content EVA with a melt index of about 0.45, available from Exxon under the trade designation ESCORENE™ XS 81.54. Another example is an EVA having 6.5%, by weight of the copolymer, of vinyl acetate comonomer, available from Huntsman under the trade designation PE 1651™. This material has a melt index of 0.5 grams/10 minutes, i.e. a fractional melt index. Other suitable materials for layer 12 include ethylene/alpha-olefin copolymer and fractional melt index low density polyethylene. Examples of ethylene alpha-olefin copolymers are linear low density polyethylenes such as DOWLEX™ 3010 having a density of 0.921 grams per cubic centimeter and EXXON LL™ 3003.37 having a density of 0.917 gms/cc, and very low density polyethylene such as ATTANE™ 4001, 4002, and 4003. These latter materials have a density of about 0.912 grams per cubic centimeter (for 4001 and 4002) and 0.905 grams per cubic centimeter (for 4003). Layer 12 can in one embodiment comprise a single site-catalyzed ethylene/alpha-olefin copolymer. An example of this is an ethylene/hexene copolymer having a density of 0.917 grams per cubic centimeter, available from ExxonMobil under the trade designation EXCEED™ 1018CA. Another example of this is an ethylene/hexene copolymer having a density of 0.900 grams per cubic centimeter, available from ExxonMobil under the trade designation EXACT™ 3132. Still another example of this is an ethylene/octene copolymer having a density of 0.917 grams per cubic centimeter, available from Dow under the trade designation ELITE™ 5400G. Layer 12 can in another embodiment comprise a single site-catalyzed propylene/ethylene copolymer. An example of this is available from Total Petrochemicals under the trade designation EOD™ 03-01. Any of the above disclosed materials can be blended in any suitable proportions for use in layer 12.

In layer 12, in one embodiment, polydimethylsiloxane is blended with an olefinic polymer such as one or more of ethylene/ester copolymer, ethylene/alpha-olefin copolymer, and fractional melt index low density polyethylene. The polydimethylsiloxane is present in the blend at a level of from 0.1% to 10%, such as from 0.5% to 8%, 1% to 6%, and 2% to 4%, by weight of the blend. A commercial example of polydimethylsiloxane is MB50-313™ available from Dow Corning, which is a masterbatch with a base resin of LLDPE, and having 50%, by weight of the masterbatch, of a high molecular weight polydimethylsiloxane.

In an alternative embodiment, a hydrophobic fluoropolymer, such as a highly hydrophobic fluoropolymer, can be substituted in whole or in part for the polydimethylsiloxane.

In at least some embodiments, layer 12 includes an antiblock agent. The antiblock agent is typically a form of silica as an active component in a masterbatch of a polyolefin. An example of this is 10853™ from Ampacet, containing about 20%, by weight of the commercial material, of silica in the form of a diatomaceous earth, blended in a host polymer, linear low density polyethylene. Another example is 101104™ from Ampacet, containing silica in the form of alkali-aluminosilicate ceramic spheres (beads) blended in a host polymer, low density polyethylene. An antiblock agent can be present in layer 12 in any suitable range, such as from 0.1% to 5% of the active silica component, by weight of layer 12.

In another alternative embodiment, layer 12 comprises a blend of an ethylene/alpha-olefin copolymer with a masterbatch having an antiblock agent and a slip agent. An example is a blend of a single site catalyzed ethylene/hexene copolymer having a density of 0.912 grams per cubic centimeter (e.g. ECD 364™ available from ExxonMobil), and a masterbatch having 70% low density polyethylene with 25% silica and 5% erucamide (e.g. FSU 255E™ available from A. Schulman). More generally in this embodiment, layer 12 can comprise a blend of 90% to 99%, by weight of the blend, of an ethylene/alpha-olefin copolymer, and 1% to 10%, by weight of the blend, of a masterbatch having an antiblock agent and a slip agent, wherein the antiblock agent comprises 25% of the masterbatch, and the slip agent comprises 5% of the masterbatch. Films of the invention can comprise an antiblock agent that comprises from 0.25% to 2.5% of the blend of layer 12, and a slip agent, such as a wax such as erucamide, that comprises from 0.05% to 0.5% of the blend of layer 12.

Layer 14 can in one embodiment comprise a very low density polyethylene (VLDPE), such as a VLDPE having a density ranging from 0.900 and 0.912 grams per cubic centimeter, e.g. ATTANE™ 4003 available from Dow, having a density of about 0.905 grams per cubic centimeter, and a melt index of about 0.80 grams per ten minutes at standard ASTM conditions. More generally, layer 14 can comprise an ethylene/alpha olefin copolymer having a density of from 0.900 to 0.920 grams per cubic centimeter. An example of this is an ethylene/hexene copolymer having a density of 0.917 grams per cubic centimeter, available from ExxonMobil under the trade designation EXCEED™ 1018CA. Another example of this is a single site catalyzed ethylene/octene copolymer having a density of 0.912 grams per cubic centimeter, available from Nova Chemicals under the trade designation SCLAIR™ FP112. Another suitable material for layer 14 is an ethylene/vinyl acetate copolymer with a fractional melt index (i.e. a melt index of less than about 1.0 grams/ten minutes) and a vinyl acetate content of at least about 12% by weight of the copolymer. One such resin is EXXON 705.16™, with a melt index of about 0.35 grams/10 minutes and a vinyl acetate content of about 12% by weight. Ionomers such as those available from du Pont under the SURLYN™ trademark, comprising metal-salt neutralized ethylene/acrylic or methacrylic acid copolymers, are also suitable for layer 14. In another embodiment, layer 14 can comprise an ethylene/vinyl acetate copolymer with a fractional melt index and a vinyl acetate content of between 2% and 18% by weight of the copolymer. One such resin is an EVA having 6.5%, by weight of the copolymer, of vinyl acetate comonomer, available from Huntsman under the trade designation PE 1651 ™. This material has a melt index of 0.5 grams/10 minutes, i.e. a fractional melt index.

In addition to the contribution to the impact resistance and abuse resistance of the final package, layer 14 can be used to carry a pigment in a pigmented film. For example, a white pigment containing titanium dioxide can be included in layer 14, so that the pigment will not have to be included in heat sealable layer 12. An example is AMPACET PE™ 11853 which contains 50% TiO₂ and 50% LLDPE. Another example is 1004™ available from Ingenia Polymers.

A first bonding layer 16 is disposed between and bonds abuse layer 14 and a first intermediate layer to be discussed in more detail below. This layer 16 may comprise any of the chemically modified polyolefins available in the market place which will provide sufficient interlaminar bond strength between layers 14 and 18. Examples include maleic anhydride-modified ethylene/vinyl acetate copolymers. An example is a modified ethylene/vinyl acetate copolymer, the EVA having a vinyl acetate content of about 9% by weight, and a melt index of about 1. A suitable resin is available from Equistar under the designation PLEXAR™ PX1007. Another suitable resin is BYNEL™ 3860 available from du Pont. Yet another suitable resin is BYNEL™ 30E670 available from du Pont. Layer 16 can comprise a blend of a modified ethylene/vinyl acetate copolymer, with ethylene/vinyl acetate copolymer, each of these two materials present in the blend in any suitable proportions.

In one embodiment, layer 16 comprises a blend of an anhydride grafted ethylene copolymer, such as an anhydride grafted ethylene/alpha olefin copolymer, having a density of from 0.916 to 0.935 grams/cubic centimeter, and a single site catalyzed ethylene/alpha-olefin copolymer having a density of from 0.85 to 0.915 grams/cubic centimeter.

An example of the anhydride grafted ethylene copolymer having a density of from 0.916 to 0.935 grams/cubic centimeter is PX3236™ available from Equistar. This material is a maleic anhydride modified LLDPE with a density of 0.921 grams/cubic centimeter.

An example of the single site catalyzed ethylene/alpha-olefin copolymer having a density of from 0.85 to 0.915 grams/cubic centimeter is AFFINITY™ EG 8100 (Dow). This material is an ethylene/1-octene copolymer with a density of 0.870 grams/cubic centimeter.

Percentages for each material in the blend of layer 16 can range from 50% to 95%, such as 60% to 90%, and 75% to 85%, of the anhydride grafted ethylene copolymer, and from 5% to 50%, such as 10% to 40%, such as 15% to 25%, of the single site catalyzed ethylene/alpha-olefin copolymer having a density of from 0.85 to 0.915 grams/cubic centimeter.

In an alternative embodiment, an anhydride grafted EVA having a vinyl acetate content, by weight of the material, of from 12 to 25%, can be substituted in whole or in part for the anhydride grafted ethylene copolymer having a density of from 0.916 to 0.935 grams/cubic centimeter, and/or the single site catalyzed ethylene/alpha-olefin copolymer having a density of from 0.85 to 0.915 grams/cubic centimeter.

Layer 16 can be used to carry a pigment such as those disclosed above for layer 14.

A first intermediate layer 18 is adhered to a surface of adhesive layer 16, and also adhered to core layer 20. This layer can comprise a copolyamide, nylon 6 or nucleated nylon 6. Two examples of nylon 6 are CAPRON™ 8209 F (Allied) and ULTRAMID™ B4 (BASF); an example of a nucleated nylon 6 is BASF 602 U™. Layer 18 can comprise any suitable copolyamide such as nylon 6/66, e.g. ULTRAMID™ C 35, a copolymer of nylon 6 and nylon 66 available from BASF, or XTRAFORM™ 1590 available from Allied. Other copolyamides useful in layer 16 include nylon 6/69 and nylon 6/12. Resins of the former type can be obtained from Custom Resins as CUSTOM™ 826. Nylon 6/12 can be obtained from Emser as CA 6™ or CR 9™ respectively. Layer 18 can comprise blends of any of these polyamides and copolyamides. In an alternative embodiment, an anhydride grafted ethylene/alpha-olefin copolymer, or an anhydride grafted EVA, or an ionomer resin, can be substituted in whole or in part for the polyamide of layer 18.

The core layer 20 comprises an ethylene vinyl alcohol copolymer (EVOH). Suitable EVOH resins are available from EVALCA and can vary in ethylene content, e.g. from 30 mole % to 40 mole % ethylene. An example is EVAL™ H 101 with an ethylene content of about 38 mole percent. In an alternative embodiment, an anhydride grafted EVA or other suitable olefinic polymer can be substituted in whole or in part for the EVOH of layer 20.

On the surface of the core layer opposite the first intermediate layer is the second intermediate layer 22 comprising any of the polyamides and/or copolyamides of layer 18.

Layers 18 and 22 can in one embodiment have the same composition, and can in one embodiment comprise the same polyamide, copolyamide, or blends thereof. Layers 18 and 22 can in an alternative embodiment differ compositionally from one another, and can in an alternative embodiment comprise different polyamides, copolyamides, or blends thereof.

Either or both of the polyamide layers 18 and 22 can in one embodiment comprise a bend of polyamide and ionomer resin (e.g. IO1). In such a blend, the ionomer resin can be present in an amount of from 1% to 20% by weight of the blend of polyamide and ionomer resin, e.g. from 2% to 18%, and from 5% to 15%. The blend of polyamide and ionomer resin can comprise from 1% by weight of either or both of layers 18 and 22, to 100% by weight of either or both of layers 18 and 22, e.g. from 10% to 90%, from 20% to 80%, from 30% to 70%, and from 40% to 60% by weight of either or both of layers 18 and 22. Where the blend is less than 100% of the respective layer, any suitable additional material can be included to make up the remainder of the layer.

The blend of a second bonding layer 24 represents a self-weldable layer comprising a polymeric adhesive. In one embodiment, layer 24 comprises a blend of an anhydride grafted ethylene copolymer, such as an anhydride grafted ethylene/alpha-olefin copolymer having a density of from 0.916 to 0.935 grams/cubic centimeter, and a single site catalyzed ethylene/alpha-olefin copolymer having a density of from 0.85 to 0.915 grams/cubic centimeter.

An example of the anhydride grafted ethylene copolymer having a density of from 0.916 to 0.935 grams/cubic centimeter is PX3236™ available from Equistar. This material is a maleic anhydride modified LLDPE with a density of 0.921 grams/cubic centimeter.

An example of the single site catalyzed ethylene/alpha-olefin copolymer having a density of from 0.85 to 0.915 grams/cubic centimeter is AFFINITY™ EG 8100 (Dow). This material is an ethylene/1-octene copolymer with a density of 0.870 grams/cubic centimeter.

Percentages for each material in the blend of layer 24 can range from 50% to 95%, such as 60% to 90%, and 75% to 85%, of the anhydride grafted ethylene copolymer, and from 5% to 50%, such as 10% to 40%, such as 15% to 25%, of the single site catalyzed ethylene/alpha-olefin copolymer having a density of from 0.85 to 0.915 grams/cubic centimeter.

In an alternative embodiment, an anhydride grafted EVA having a vinyl acetate content, by weight of the material, of from 12 to 25%, can be substituted in whole or in part for the anhydride grafted ethylene copolymer having a density of from 0.916 to 0.935 grams/cubic centimeter, and/or the single site catalyzed ethylene/alpha-olefin copolymer having a density of from 0.85 to 0.915 grams/cubic centimeter. Examples of suitable resins and materials for layer 24 include those materials disclosed herein for first bonding layer 16.

When the tubular film is collapsed during production of the film, layer 24 will self-weld to itself.

Interface 26 represents the point of contact between self-weldable layers 24 when the tubular film is collapsed.

### EXAMPLES

Fifteen film formulations were made in accordance with the invention. The film structures, and thickness % of each layer, are identified below. Resins used in these films are identified in the list of Table 1.

TABLE 1
Resin Identification

| Material | Tradename Or | |
|---|---|---|
| Code | Designation | Source(s) |
| AB1 | FSU 255E ™ | A. Schulman |
| AB2 | 10,075ACP ™ SYLOID | Teknor Color |
| | CONCENTRATE | |
| AB3 | 10853 ™ | Ampacet |
| AB4 | FSU 82E ™ | A. Schulman |
| AB5 | 101104 ™ | Ampacet |
| AB6 | LV146221 | Ampacet |
| AB7 | 10850 ™ | Ampacet |
| AB8 | LV143769 | Ampacet |
| PE1 | ECD ™364 | ExxonMobil |
| PE2 | XUS ™ 61520.15L | Dow |
| PE3 | AFFINITY ™ EG 8100 | Dow |
| PE4 | ATTANE ™ 4203 | Dow |
| PE5 | SCLAIR ™ FP112 | Nova Chemicals |
| PE6 | EXACT ™ 3132 | ExxonMobil |
| PE7 | DOW 609A ™ | Dow |
| PE8 | ELITE ™ 5400G | Dow |
| PE9 | EXCEED ™ 1018CA | ExxonMobil |
| PP1 | EOD ™ 03-01 | Total Petrochemicals |
| AD1 | PLEXAR ™ PX1007 | Equistar |
| AD2 | BYNEL ™ 30E670 | DuPont |
| OB1 | SOARNOL ™ ET3803 | Nippon Gohsei |
| PA1 | ULTRAMID ™B40 01 | BASF |
| IO1 | SURLYN ™ AM7927 | DuPont |
| SL1 | MB50-313 ™ | Dow Corning |
| EV1 | PE 1651 ™ | Huntsman |

AB1 is a masterbatch having 70%, by weight of the masterbatch, of low density polyethylene, 25%, by weight of the masterbatch, of an antiblocking agent (silica in the form of diatomaceous earth), and 5%, by weight of the masterbatch, of a slip agent (erucamide).

AB2 is a masterbatch having about 90%, by weight of the masterbatch, of low density polyethylene, and about 10%, by weight of the masterbatch, of an antiblocking agent (SYLOID™ silica).

AB3 is a masterbatch having about 20%, by weight of the commercial material, of silica in the form of a diatomaceous earth, blended in a host polymer, linear low density polyethylene.

AB4 is a masterbatch having 90%, by weight of the masterbatch, of low density polyethylene, 8.25%, by weight of the masterbatch, of an antiblocking agent (MICROKEN 801™), 1.65%, by weight of the masterbatch, of a slip agent (erucamide), and a stabilizer.

AB5 is a masterbatch having silica in the form of alkali-aluminosilicate ceramic spheres (beads), blended in a host polymer, linear low density polyethylene.

AB6 is a masterbatch having about 88%, by weight of the masterbatch, of low density polyethylene; about 8%, by weight of the masterbatch, of SILTON JC30™, an aluminosilicate; about 2 w %, by weight of the masterbatch, of CLEAR BLOC 80™ talc, an antiblocking agent; and about 2%, by weight of the masterbatch, of erucamide, a slip agent.

AB7 is a masterbatch having about 13.3%, by weight of the commercial material, of silica in the form of a diatomaceous earth; and about 1%, by weight of the masterbatch, of erucamide, a slip agent, blended in a host polymer, linear low density polyethylene.

AB8 is a masterbatch having about 20%, by weight of the commercial material, of silica in the form of a diatomaceous earth; and about 12.5%, by weight of the masterbatch, of SL1 (see below), blended in a host polymer, linear low density polyethylene.

PE1 is a single site catalyzed ethylene/hexene copolymer having a density of 0.912 grams per cubic centimeter.

PE2 is an ethylene/1-octene copolymer with a density of 0.903 grams per cubic centimeter and a 1-octene content of 11.5% by weight of the copolymer.

PE3 is a single site catalyzed ethylene/1-octene copolymer having a density of 0.870 grams/cubic centimeter.

PE4 is an ethylene/1-octene copolymer with a density of 0.905 grams per cubic centimeter and a 1-octene content of 11.5% by weight of the copolymer.

PE5 is a single site catalyzed ethylene/octene copolymer having a density of 0.912 grams per cubic centimeter.

PE6 is an ethylene/hexene copolymer having a density of 0.900 grams per cubic centimeter.

PE7 is a low density polyethylene.

PE8 is an ethylene/octene interpenetrating network copolymer having a density of 0.917 grams per cubic centimeter.

PE9 is an ethylene/hexene copolymer having a density of 0.917 grams per cubic centimeter.

PP1 is a single site-catalyzed propylene/ethylene copolymer.

AD1 is a maleic anhydride-modified ethylene/vinyl acetate copolymer, the EVA having a vinyl acetate content of about 9% by weight, and a melt index of about 1.

AD2 is a maleic anhydride-modified ethylene/vinyl acetate copolymer having a melt flow rate of 0.9 grams/10 minutes.

OB1 is an ethylene/vinyl alcohol copolymer with from 30 to 40 mole % ethylene.

PA1 is a nylon 6 (poly(caprolactam)).

IO1 is a pre-blend of partially zinc neutralized ethylene/methacrylic acid copolymer (ionomer resin) and nylon 6.

SL1 is a slip masterbatch having a base resin of linear low density polyethylene (LLDPE), and having 50%, by weight of the masterbatch, of a high molecular weight polydimethylsiloxane.

EV1 is an EVA having 6.5%, by weight of the copolymer, of vinyl acetate comonomer.

All compositional percentages given herein are by weight, unless indicated otherwise.

Examples 1 to 19 were 1 mil thick when extruded as tubular film, and collapsed in each case to make a 2 mil thick film. The thickness of each layer, as a percentage of the total thickness of the film of each example, is given below the composition of each layer.

### Example 1

| | | Abuse | Tie | nylon | oxygen | nylon | |
|---|---|---|---|---|---|---|---|
| | Sealant | layer | layer | layer | barrier | layer | tie |
| | 97% PE1 + | 80% PE1 + | AD1 | PA1 | OB1 | PA1 | 80% AD1 + |
| | 3% AB1 | 20% PE2 | | | | | 20% PE3 |
| thickness % | 20 | 28 | 9 | 13 | 8 | 13 | 9 |

### Example 2

| | | Abuse | Tie | nylon | oxygen | nylon | |
|---|---|---|---|---|---|---|---|
| | Sealant | layer | layer | layer | barrier | layer | tie |
| | 97% PE1 + | 50% PE1 + | AD1 | PA1 | OB1 | PA1 | 80% AD1 + |
| | 3% AB1 | 50% PE4 | | | | | 20% PE3 |
| thickness % | 20 | 28 | 9 | 13 | 8 | 13 | 9 |

### Example 3

| | | Abuse | Tie | nylon | oxygen | nylon | |
|---|---|---|---|---|---|---|---|
| | Sealant | layer | layer | layer | barrier | layer | tie |
| | 97% PE1 + | PE1 | AD1 | 90% PA1 + | OB1 | 90% PA1 + | 80% AD1 + |
| | 3% AB1 | | | 10% IO1 | | 10% IO1 | 20% PE3 |
| thickness % | 20 | 28 | 9 | 13 | 8 | 13 | 9 |

### Examples 4 to 19

| | Sealant | Abuse | Tie | nylon | oxygen | nylon | Tie |
|---|---|---|---|---|---|---|---|
| Examples | Layer | layer | layer | layer | barrier | layer | layer |
| 4 | 68% PE1 + | PE1 | 80% AD1 + | 90% PA1 + | OB1 | 90% PA1 + | 80% AD1 + |
| | 25% EV1 + | | 20% PE3 | 10% IO1 | | 10% IO1 | 20% PE3 |
| | 4% AB3 + | | | | | | |
| | 3% AB1 | | | | | | |
| | 20% | 28% | 9% | 13% | 8% | 13% | 9% |
| 5 | 67% PE1 + | PE1 | 80% AD1 + | 90% PA1 + | OB1 | 90% PA1 + | 80% AD1 + |
| | 25% EV1 + | | 20% PE3 | 10% IO1 | | 10% IO1 | 20% PE3 |
| | 4% AB3 + | | | | | | |
| | 4% AB1 | | | | | | |
| | 20% | 28% | 9% | 13% | 8% | 13% | 9% |
| 6 | 92% PE1 + | 82% PE1 + | 80% AD1 + | 90% PA1 + | OB1 | 90% PA1 + | 80% AD1 + |
| | 4% AB3 + | 18% EV1 | 20% PE3 | 10% IO1 | | 10% IO1 | 20% PE3 |
| | 4% AB1 | | | | | | |
| | 20% | 28% | 9% | 13% | 8% | 13% | 9% |
| 7 | 92% PE1 + | 82% PE5 + | 80% AD1 + | 90% PA1 + | OB1 | 90% PA1 + | 80% AD1 + |
| | 4% AB3 + | 18% EV1 | 20% PE3 | 10% IO1 | | 10% IO1 | 20% PE3 |
| | 4% AB1 | | | | | | |
| | 20% | 28% | 9% | 13% | 8% | 13% | 9% |
| 8 | 48% PP1 + | 82% PE5 + | 80% AD2 + | 90% PA1 + | OB1 | 90% PA1 + | 80% AD2 + |
| | 44% PE6 + | 18% EV1 | 20% PE3 | 10% IO1 | | 10% IO1 | 20% PE3 |
| | 4% AB3 + | | | | | | |
| | 4% AB1 | | | | | | |
| | 20% | 28% | 9% | 13% | 8% | 13% | 9% |
| 9 | 48% PP1 + | 82% PE1 + | 80% AD1 + | 90% PA1 + | OB1 | 90% PA1 + | 80% AD1 + |
| | 44% PE6 + | 18% EV1 | 20% PE3 | 10% IO1 | | 10% IO1 | 20% PE3 |
| | 4% AB3 + | | | | | | |
| | 4% AB1 | | | | | | |
| | 20% | 28% | 9% | 13% | 8% | 13% | 9% |
| 10 | 63% PE1 + | PE1 | 80% AD1 + | 90% PA1 + | OB1 | 90% PA1 + | 80% AD1 + |
| | 25% PE7 + | | 20% PE3 | 10% IO1 | | 10% IO1 | 20% PE3 |
| | 4% AB3 + | | | | | | |
| | 4% AB1 + | | | | | | |
| | 4% AB5 | | | | | | |
| | 20% | 28% | 9% | 13% | 8% | 13% | 9% |
| 11 | 85% PE1 + | 50% PE1 + | 80% AD1 + | 90% PA1 + | OB1 | 90% PA1 + | 80% AD1 + |
| | 5% AB3 + | 50% EV1 | 20% PE3 | 10% IO1 | | 10% IO1 | 20% PE3 |
| | 5% AB1 + | | | | | | |
| | 5% AB5 | | | | | | |
| | 20% | 28% | 9% | 13% | 8% | 13% | 9% |
| 12 | 65% PE8 + | 50% PE1 + | 80% AD1 + | 90% PA1 + | OB1 | 90% PA1 + | 80% AD1 + |
| | 25% PE7 + | 50% EV1 | 20% PE3 | 10% IO1 | | 10% IO1 | 20% PE3 |
| | 3% AB3 + | | | | | | |
| | 3% AB1 | | | | | | |
| | 10% | 38% | 9% | 13% | 8% | 13% | 9% |
| 13 | 45% PE8 + | PE1 | 80% AD1 + | 90% PA1 + | OB1 | 90% PA1 + | 80% AD1 + |
| | 40% EV1 + | | 20% PE3 | 10% IO1 | | 10% IO1 | 20% PE3 |
| | 5% AB3 + | | | | | | |
| | 5% AB1 + | | | | | | |
| | 5% AB5 | | | | | | |
| | 20% | 28% | 9% | 13% | 8% | 13% | 9% |
| 14 | 65% PE9 + | PE9 | 80% AD1 + | 90% PA1 + | OB1 | 90% PA1 + | 80 % AD1+ |
| | 25% PE7 + | | 20% PE3 | 10% IO1 | | 10% IO1 | 20% PE3 |
| | 5% AB3 + | | | | | | |
| | 5% AB1 | | | | | | |
| | 20% | 28% | 9% | 13% | 8% | 13% | 9% |
| 15 | 91% PE1 + | PE1 | 80% AD1 + | 90% PA1 + | OB1 | 90% PA1 + | 80% AD1 + |
| | 9% AB4 | | 20% PE3 | 10% IO1 | | 10% IO1 | 20% PE3 |
| | 20% | 28% | 9% | 13% | 8% | 13% | 9% |
| 16 | 69% PE8 + | PE4 | 80% AD1 + | PA1 | OB1 | PA1 | 80% AD1 + |
| | 23% PE7 + | | 20% PE3 | | | | 20% PE3 |
| | 7% AB3 + | | | | | | |
| | 1% SL1 | | | | | | |
| | 20% | 28% | 9% | 13% | 8% | 13% | 9% |
| 17 | 65% PE9 + | PE1 | 80% AD1 + | 90% PA1 + | OB1 | 90% PA1 + | 80% AD1 + |
| | 25% PE7 + | | 20% PE3 | 10% IO1 | | 10% IO1 | 20% PE3 |
| | 10% AB7 | | | | | | |
| | 20% | 28% | 9% | 13% | 8% | 13% | 9% |
| 18 | 68% PE8 + | PE1 | 80% AD1 + | 90% PA1 + | OB1 | 90% PA1 + | 80% AD1 + |
| | 25% PE7 + | | 20% PE3 | 10% IO1 | | 10% IO1 | 20% PE3 |
| | 7% AB8 | | | | | | |
| | 20% | 28% | 9% | 13% | 8% | 13% | 9% |
| 19 | 64% PE1 + | PE1 | 80% AD1 + | 90% PA1 + | OB1 | 90% PA1 + | 80% AD1 + |
| | 25% PE7 + | | 20% PE3 | 10% IO1 | | 10% IO1 | 20% PE3 |
| | 4% AB3 + | | | | | | |
| | 3% AB1 + | | | | | | |
| | 4% AB5 | | | | | | |
| | 20% | 28% | 9% | 13% | 8% | 13% | 9% |

Additional prophetic examples, of the same total thickness as in Examples 1 to 19, are as follows:

| | | | | | | | |
|---|---|---|---|---|---|---|---|
| 20 | 67% PE1 + | PE1 | 80% AD1 + | 90% PA1 + | OB1 | 90% PA1 + | 80% AD1 + |
| | 25% EV1 + | | 20% PE3 | 10% IO1 | | 10% IO1 | 20% PE3 |
| | 8% AB6 | | | | | | |
| | 20% | 28% | 9% | 13% | 8% | 13% | 9% |
| 21 | 92% PE1 + | 82% PE1 + | 80% AD1 + | 90% PA1 + | OB1 | 90% PA1 + | 80% AD1 + |
| | 8% AB6 | 18% EV1 | 20% PE3 | 10% IO1 | | 10% IO1 | 20% PE3 |
| | 20% | 28% | 9% | 13% | 8% | 13% | 9% |

Alternative formulations for the sealant layer can comprise one or more of the following:
96% PE1+4% AB1
89% PE1+10% AB2+1% SL1.
89.8PE1+10% AB2+0.2% erucamide.
96% PE1+3% AB1+1% SL1.

The second tie layer (the self-weld layer) can alternatively comprise one or more of the following:
AD1
80% AD1+20% PE3

Various modifications will become evident to those skilled in the art after a review of the specification. These modifications are deemed to be within the scope of the invention as claimed below.

The film of the invention can be cross-linked or non-cross-linked, oriented or unoriented (i.e. not solid state oriented), heat shrinkable or non-heat shrinkable. Where the film is heat shrinkable, it has a total free shrink at 85° C. (185° F.) of from 10 to 100%. All or a portion of the film of the present invention can be irradiated to induce crosslinking. In the irradiation process, the film is subjected to an energetic radiation treatment, such as corona discharge, plasma, flame, ultraviolet, X-ray, gamma ray, beta ray, and high energy electron treatment, which induces crosslinking between molecules of the irradiated material. The proper dosage level can be determined by standard dosimetry methods known to those of ordinary skill in the art, and the precise amount of radiation to be used is of course dependent on the particular film structure and its end use. The film can be irradiated at a level of from 0.5-15 megarads (MR), such as 1-12 MR. Further details on the irradiation of polymeric films can be found in, for example, U.S. Pat. No. 4,064,296 (Bornstein et al.), U.S. Pat. No. 4,120,716 (Bonet), and U.S. Pat. No. 4,879,430 (Hoffman), all incorporated herein by reference in their entirety.

Films of the invention can be made by tubular coextrusion, and by extrusion coating. In the latter case, a substrate is extruded or coextruded, optionally irradiated, then optionally stretch oriented.

The polymeric components used to fabricate film according to the present invention can also contain appropriate amounts of other additives normally included in or blended with such compositions. These include slip agents, antioxidants, fillers, dyes, pigments, radiation stabilizers, antistatic agents, elastomers, and other additives known to those of skill in the art of packaging films.

The multilayer film of the present invention can have any total number of layers and any total thickness desired as long as the film provides the desired properties for the particular packaging operation in which the film is used

The film of the invention can be laminated, adhesively adhered, extrusion coated, or extrusion laminated onto a substrate to form a laminate. Lamination can be accomplished by joining layers with adhesives, joining with heat and pressure, and even spread coating and extrusion coating.

A package can be made, with the above-disclosed film, by conventional techniques and in a conventional packaging format.

Although multilayer films and tubular lay-flat films have been disclosed herein with respect to the packaging of comminuted products such as ground beef, those skilled in the art will appreciate, upon review of this disclosure, that articles of the invention can be used in the packaging of other food and non-food products. As an example, a film of the invention can be used in automotive applications, e.g. in connection with the headliner of an automobile.

Although tubular and multilayer films of the invention can be provided in either non-oriented (i.e. not solid state oriented) or solid-state oriented embodiments, in the packaging of comminuted beef products, it is beneficial to use non-oriented embodiments of the invention.

What is claimed is:

1. A tubular lay-flat film comprising:
b) first and second outer layers comprising an olefinic polymer;
c) at least one intermediate layer comprising polyamide; and
d) first and second internal self-welded layers in contact with one another, the first and second internal self welded layers comprising an olefinic polymer;
wherein the first and second outer polymeric layers each comprise a blend of
i) an olefinic polymer, and
ii) polydimethylsiloxane.

2. The tubular lay-flat film of claim 1 wherein the olefinic polymer of the first layer comprises a material selected from the group consisting of:
a) ethylene/alpha-olefin copolymer;
b) fractional melt index low density polyethylene;
c) ethylene/ester copolymer; and
d) ethylene/vinyl acetate copolymer having a vinyl acetate content of from 4 to 12% by weight of the copolymer.

3. The tubular lay-flat film of claim 1 wherein the polyamide comprises a material selected from the group consisting of:
(i) nylon 6;
(ii) nylon 6/12;
(iii) nylon 6/66; and
(iv) nylon 6/69.

4. The tubular lay-flat film of claim 1 wherein the first and second outer polymeric layers each comprise a blend of from 90% to 99.9%, by weight of the blend, of olefinic polymer, and from 0.1% to 10%, by weight of the blend, of polydimethylsiloxane.

5. A tubular lay-flat film comprising:
a) first and second outer layers comprising an olefinic polymer;
b) at least one intermediate layer comprising a blend of polyamide and ionomer resin; and
c) first and second internal self welded layers in contact with one another, the first and second internal self welded layers comprising an olefinic polymer.

6. The tubular lay-flat film of claim 5 wherein the olefinic polymer of the first layer comprises a material selected from the group consisting of:
a) ethylene/alpha-olefin copolymer;
b) fractional melt index low density polyethylene;
c) ethylene/ester copolymer; and
d) ethylene/vinyl acetate copolymer having a vinyl acetate content of from 4 to 12% by weight of the copolymer.

7. The tubular lay-flat film of claim 5 wherein the polyamide comprises a material selected from the group consisting of:
(i) nylon 6;
(ii) nylon 6/12;
(iii) nylon 6/66; and
(iv) nylon 6/69.

8. The tubular lay-flat film of claim 5 wherein the at least one intermediate layer comprises a blend of from 80% to 99%, by weight of the blend, of polyamide, and from 1% to 20%, by weight of the blend, of ionomer resin.

9. A tubular lay-flat film comprising:
a) first and second outer layers comprising an olefinic polymer;
b) at least one intermediate layer comprising polyamide; and
c) first and second internal self-welded layers in contact with one another, the first and second internal self welded layers each comprising a blend of
i) an anhydride grafted ethylene copolymer having a density of from 0.916 to 0.935 grams/cubic centimeter, and
ii) a single site catalyzed ethylene/alpha-olefin copolymer having a density of from 0.85 to 0.915 grams/cubic centimeter.

10. The tubular lay-flat film of claim 9 wherein the olefinic polymer of the first layer comprises a material selected from the group consisting of:
a) ethylene/alpha-olefin copolymer;
b) fractional melt index low density polyethylene;
c) ethylene/ester copolymer; and
d) ethylene/vinyl acetate copolymer having a vinyl acetate content of from 4 to 12% by weight of the copolymer.

11. The tubular lay-flat film of claim 9 wherein the polyamide comprises a material selected from the group consisting of:
(i) nylon 6;
(ii) nylon 6/12;
(iii) nylon 6/66; and
(iv) nylon 6/69.

12. The tubular lay-flat film of claim 9 wherein the first and second internal self welded layers each comprises a blend of from 50% to 95%, by weight of the blend, of the anhydride grafted ethylene copolymer having a density of from 0.916 to 0.935 grams/cubic centimeter, and from 5% to 50%, by weight of the blend, of the single site catalyzed ethylene/alpha-olefin copolymer having a density of from 0.85 to 0.915 grams/cubic centimeter.

13. A multilayer film comprising:
a) a first layer comprising a blend of
i) an olefinic polymer, and
ii) polydimethylsiloxane;
b) a second layer comprising an olefinic polymer;
c) a third layer comprising a polyolefinic adhesive;
d) a fourth layer comprising a polyamide;
e) a fifth layer comprising an ethylene/vinyl alcohol copolymer;
f) a sixth layer comprising a polyamide; and
g) a seventh layer comprising a polymeric adhesive.

14. The multilayer film of claim 13 wherein the olefinic polymer of the first layer comprises a material selected from the group consisting of:
a) ethylene/alpha-olefin copolymer;
b) fractional melt index low density polyethylene;
c) ethylene/ester copolymer; and
d) ethylene/vinyl acetate copolymer having a vinyl acetate content of from 4 to 12% by weight of the copolymer.

15. The multilayer film of claim 13 wherein the first layer comprises a blend of from 90% to 99.9%, by weight of the blend, of the olefinic polymer, and from 0.1% to 10%, by weight of the blend, of the polydimethylsiloxane.

16. The multilayer film of claim 13 wherein the olefinic polymer of the second layer comprises a material selected from the group consisting of:
a) ethylene/alpha-olefin copolymer with a density of from 0.85 to 0.915 grams/cubic centimeter;
b) fractional melt index ethylene/vinyl acetate copolymer having a vinyl acetate content of from 2 to 18% by weight of the copolymer; and
c) ionomer resin.

17. The multilayer film of claim 13 wherein the polyolefinic adhesive of the third layer comprise an anhydride grafted ethylene vinyl acetate copolymer.

18. The multilayer film of claim 13 wherein the polyamide comprises a material selected from the group consisting of:
(i) nylon 6;
(ii) nylon 6/12;
(iii) nylon 6/66; and
(iv) nylon 6/69.

19. The multilayer film of claim 13 wherein the film is collapsed on itself to form a double wound lay flat film, such that the seventh layer is welded to itself, and the first layer forms the outside surface of the double wound lay flat film.

20. A multilayer film comprising:
a) a first layer comprising an olefinic polymer;
b) a second layer comprising an olefinic polymer;
c) a third layer comprising a polyolefinic adhesive;
d) a fourth layer comprising a blend of polyamide and ionomer resin;
e) a fifth layer comprising an ethylene/vinyl alcohol copolymer;
f) a sixth layer comprising a blend of polyamide and ionomer resin; and
g) a seventh layer comprising a polymeric adhesive.

21. The multilayer film of claim 20 wherein the olefinic polymer of the first layer comprises a material selected from the group consisting of:
a) ethylene/alpha-olefin copolymer;
b) fractional melt index low density polyethylene;
c) ethylene/ester copolymer; and
d) ethylene/vinyl acetate copolymer having a vinyl acetate content of from 4 to 12% by weight of the copolymer.

22. The multilayer film of claim 20 wherein the olefinic polymer of the second layer comprises a material selected from the group consisting of:
a) ethylene/alpha-olefin copolymer with a density of from 0.85 to 0.915 grams/cubic centimeter;
b) fractional melt index ethylene/vinyl acetate copolymer having a vinyl acetate content of from 2 to 18% by weight of the copolymer; and
c) ionomer resin.

23. The multilayer film of claim 20 wherein the polyolefinic adhesive of the third layer comprise an anhydride grafted ethylene vinyl acetate copolymer.

24. The multilayer film of claim 20 wherein the polyamide comprises a material selected from the group consisting of:
(i) nylon 6;
(ii) nylon 6/12;
(iii) nylon 6/66; and
(iv) nylon 6/69.

25. The multilayer film of claim 20 wherein the fourth and sixth layers each comprise a blend of from 80% to 99%, by weight of the blend, of polyamide, and from 1% to 20%, by weight of the blend, of ionomer resin.

26. The multilayer film of claim 20 wherein the film is collapsed on itself to form a double wound lay flat film, such that the seventh layer is welded to itself, and the first layer forms the outside surface of the double wound lay flat film.

27. A multilayer film comprising:
a) a first layer comprising an olefinic polymer;
b) a second layer comprising an olefinic polymer;
c) a third layer comprising a polyolefinic adhesive;
d) a fourth layer comprising a polyamide;
e) a fifth layer comprising an ethylene/vinyl alcohol copolymer;
f) a sixth layer comprising a polyamide; and
g) a seventh layer comprising a blend of
i) an anhydride grafted ethylene copolymer having a density of from 0.916 to 0.935 grams/cubic centimeter, and
ii) a single site catalyzed ethylene/alpha-olefin copolymer having a density of from 0.85 to 0.915 grams/cubic centimeter.

28. The multilayer film of claim 27 wherein the olefinic polymer of the first layer comprises a material selected from the group consisting of:
a) ethylene/alpha-olefin copolymer;
b) fractional melt index low density polyethylene;
c) ethylene/ester copolymer; and
d) ethylene/vinyl acetate copolymer having a vinyl acetate content of from 4 to 12% by weight of the copolymer.

29. The multilayer film of claim 27 wherein the olefinic polymer of the second layer comprises a material selected from the group consisting of:
a) ethylene/alpha-olefin copolymer with a density of from 0.85 to 0.915 grams/cubic centimeter;
b) fractional melt index ethylene/vinyl acetate copolymer having a vinyl acetate content of from 2 to 18% by weight of the copolymer; and
c) ionomer resin.

30. The multilayer film of claim 27 wherein the polyolefinic adhesive of the third layer comprise an anhydride grafted ethylene vinyl acetate copolymer.

31. The multilayer film of claim 27 wherein the polyamide comprises a material selected from the group consisting of:
(i) nylon 6;
(ii) nylon 6/12;
(iii) nylon 6/66; and
(iv) nylon 6/69.

32. The multilayer film of claim 27 wherein the seventh layer comprises a blend of from 50% to 95%, by weight of the blend, of the anhydride grafted ethylene copolymer having a density of from 0.916 to 0.935 grams/cubic centimeter, and from 5% to 50%, by weight of the blend, of the single site catalyzed ethylene/alpha-olefin copolymer having a density of from 0.85 to 0.915 grams/cubic centimeter.

33. The multilayer film of claim 27 wherein the film is collapsed on itself to form a double wound lay flat film, such that the seventh layer is welded to itself, and the first layer forms the outside surface of the double wound lay flat film.

34. A process for packaging a comminuted food substance comprising:
a) packaging the comminuted food substance in a vertical form/fill/seal process, in a tubular lay-flat film comprising
i) first and second outer layers comprising an olefinic polymer,
ii) at least one intermediate layer comprising a polyamide, and
iii) first and second internal self welded layers in contact with one another, the first and second internal self welded layers comprising an olefinic polymer,
wherein the first and second outer polymeric layers each comprise a blend of an olefinic polymer, and polydimethylsiloxane, such that a chub package is made;
b) passing the chub package through a blast freezer; and
c) removing the chub package from the blast freezer; and
d) packing the chub package in a shipping container.

35. A process for packaging a comminuted food substance comprising:
a) packaging the comminuted food substance in a vertical form/fill/seal process in a tubular lay-flat film comprising
i) first and second outer layers comprising an olefinic polymer,
ii) at least one intermediate layer comprising a blend of polyamide and ionomer resin, and
iii) first and second internal self welded layers in contact with one another, the first and second internal self-welded layers comprising an olefinic polymer,
such that a chub package is made;
b) passing the chub package through a blast freezer;
c) removing the chub package from the blast freezer; and
d) packing the chub package in a shipping container.

36. A process for packaging a comminuted food substance comprising:
a) packaging the comminuted food substance in a vertical form/fill/seal process, in a tubular lay-flat film comprising
i) first and second outer layers comprising an olefinic polymer,
ii) at least one intermediate layer comprising a polyamide, and
iii) first and second internal self welded layers in contact with one another, the first and second internal self welded layers each comprising a blend of an anhydride grafted ethylene/alpha-olefin copolymer having a density of from 0.916 to 0.935 grams/cubic centimeter, and a single site catalyzed ethylene/alpha-olefin copolymer having a density of from 0.85 to 0.915 grams/cubic centimeter,
such that a chub package is made;
b) passing the chub package through a blast freezer; and
c) removing the chub package from the blast freezer; and
d) packing the chub package in a shipping container.
